(19) United States
(12) Patent Application Publication
(10) Pub. No.: US 2011/0191784 A1
(43) Pub. Date: Aug. 4, 2011

(54) PROCESSING OBSERVABLE EVENTS USING JOIN PATTERNS

(75) Inventors: Henricus Johannes Maria Meijer, Mercer Island, WA (US); John Wesley Dyer, Monroe, WA (US); Claudio Vittorio Russo, Cambridge (GB)

(73) Assignee: Microsoft Corporation, Redmond, WA (US)

(21) Appl. No.: 12/698,159

(22) Filed: Feb. 2, 2010

(51) Int. Cl. G06F 9/46

(52) U.S. Cl. 719/318

(57) ABSTRACT

Methods, systems, and computer-readable media of processing observable events using join patterns are disclosed. A particular method includes receiving a first notification indicating an occurrence of a first observable event and a second notification indicating an occurrence of a second observable event. The method also includes determining that the first and second notifications satisfy a join pattern. The method may further include taking one or more actions in response to determining that the join pattern has been satisfied.

### BACKGROUND

Multi-threaded software programs can be synchronous or asynchronous. In synchronous programs, a calling thread typically blocks and waits until a called function (e.g., executed by another thread) has terminated. In contrast, asynchronous programming enables the calling thread to call the function without blocking. While the called function executes, the calling thread may perform other computational tasks and may process results of the called function once the called function has terminated.

Current programming languages and methodologies provide little support for the asynchronous programming model. For example, it may currently be difficult for programmers to develop and maintain code that coordinates multiple asynchronous tasks and includes conditional calls to asynchronous functions.

### SUMMARY

A framework to synchronize processing of multiple observable events is disclosed. In the framework, observable events may be enqueued as they are received. A source thread may “push” observable events as they occur and one or more registered observer threads may enqueue the pushed observable events for processing. A state machine may determine whether the enqueued observable events satisfy a join pattern. The join pattern may include logical disjunctions, logical conjunctions, logical negations, or some combination thereof. For example, two types of observable events A and B may exist, and a join pattern that is satisfied when both of the observable events have occurred may be “A and B.” The join pattern may be associated with a delegate, and the body of the delegate may be executed when the join pattern is satisfied. Thus, join patterns may allow conditional asynchronous processing of observable events. For example, the join pattern “A and B” may serve as a triggering precondition for execution of a delegate function “ProcessAandB( ).”

Aspects of processing observable events using join patterns may be illustrated by considering keno, a casino variation of bingo, the popular party game. For example, consider a keno game where each player marks up to 20 of 80 spots on their keno ticket, the spots numbered from 1 to 80. Casino staff then proceeds to randomly draw 20 out of the 80 possible numbers. As each subsequently drawn number is announced, the players determine whether or not the announced number is marked on their ticket. The casino may pay tickets with exactly 0, 1, 2, 3, or 7+ numbers “hit.” Because numbers are “pushed” out to players at the casino's discretion, rather than “pulled” by the players one at a time, a software implementation of keno is well-suited to asynchronous programming. In such an implementation, each player's keno ticket may run on a separate thread, and the payout scenarios for each player may be represented by a join pattern. For example, if a player marks the numbers “25,” “32,” and “40” on their ticket, the list of possible 2-hit payouts may be represented by “(25 and 32) or (25 and 40) or (32 and 40).” 0-hit, 1-hit, and 3-hit payout scenarios may similarly be represented, and a logical disjunction of all payout scenarios may represent the precondition for executing a delegate function (e.g., CashWinningTicket( )).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of a particular embodiment of a system of processing observable events using join patterns;

FIG. 2 is a screenshot to illustrate a particular embodiment of a user interface (UI) that uses processing of observable events using join patterns;

FIG. 3 is a diagram to illustrate a particular embodiment of operation of the UI of FIG. 2;

FIG. 4 is a diagram to illustrate pseudocode associated with the UI of FIG. 2;

FIG. 5 is a diagram to illustrate particular embodiments of observable stream termination at the system of FIG. 1;

FIG. 6 is a flow diagram to illustrate a particular embodiment of a method of processing observable events using join patterns;

FIG. 7 is a flow diagram to illustrate another particular embodiment of a method of processing observable events using join patterns; and

FIG. 8 is a block diagram of a computing environment including a computing device operable to support embodiments of computer-implemented methods, computer program products, and system components as illustrated in FIGS. 1-7.

### DETAILED DESCRIPTION

Systems, methods, and computer-readable media to process observable events using join patterns are disclosed. In a particular embodiment, a computer system includes a processor configured to execute a plurality of observers at a plurality of execution threads. Each observer is configured to detect one or more occurrences of a particular observable event of a plurality of observable events. The computer system also includes a memory storing instructions, that when executed by the processor, cause execution of a state machine configured to receive notifications associated with occurrences of the plurality of observable events from the plurality of observers. The state machine is also configured to determine that a particular set of received notifications satisfies a join pattern.

In another particular embodiment, a computer-implemented method includes receiving a first notification from a first execution thread of a processor. The first notification indicates an occurrence of a first observable event of a plurality of observable events. The method also includes receiving a second notification from a second execution thread of the processor, where the second notification indicates an occurrence of a second observable event of the plurality of observable events. The method further includes determining that the first notification and the second notification satisfy a join pattern. The join pattern includes a logical disjunction of one or more logical conjunctions.

In another particular embodiment, a computer-readable medium includes instructions, that when executed by a computer, cause the computer to execute a first execution thread configured to detect occurrences of a first observable event of a source collection of observable events and a second execution thread configured to detect occurrences of a second observable event of the source collection of observable events. The instructions also cause the computer to receive a first notification that the first observable event has occurred and to receive a second notification that the second observable event has occurred. The instructions further cause the computer to determine that the first notification and the second notification satisfy a join pattern associated with a delegate, where the join pattern comprises a logical disjunction of one or more logical conjunctions. The instructions cause the computer to output a target observable event to a target observable stream.

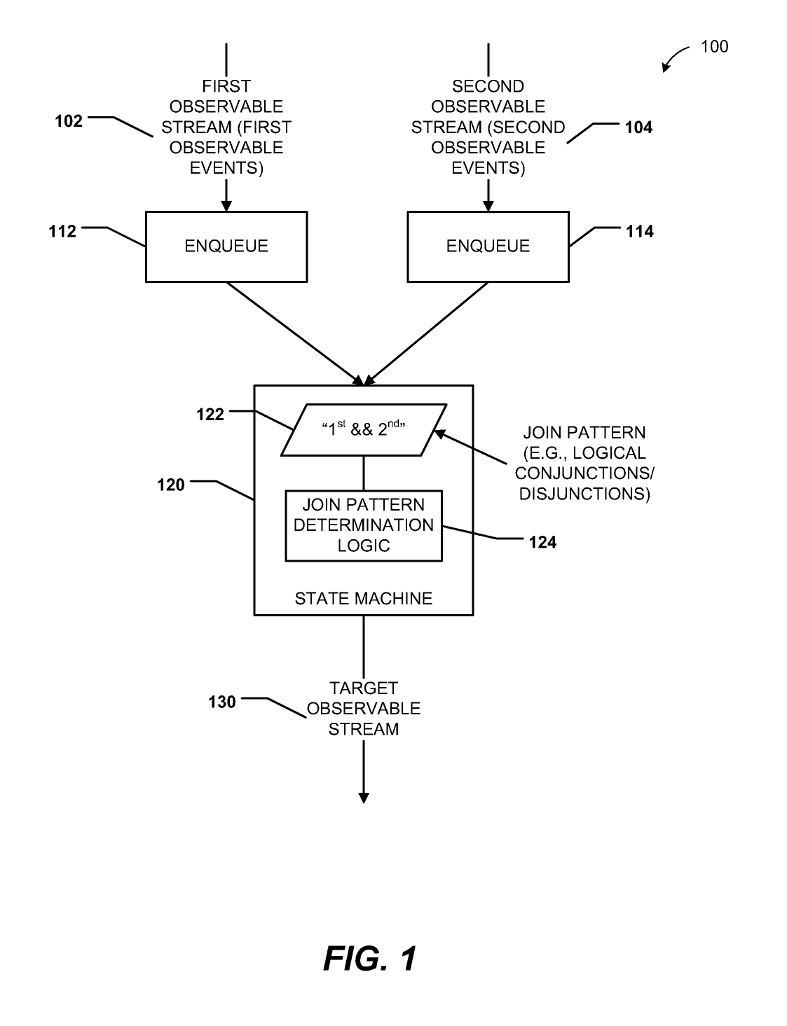

FIG. 1 depicts a particular embodiment of a system 100 of processing observable events using join patterns. The system 100 includes a state machine 120 coupled to a first observable stream 102 and a second observable stream 104, via a first enqueue operation 112 and a second enqueue operation 114, respectively. The state machine 120 may also be coupled to a target observable stream 130.

In a particular embodiment, the enqueue operations 112 and 114 are implemented by observers. For example, an observer may be an instantiation of an observer software class. In a particular embodiment, observables and observers are implemented in accordance with the following interface declarations:

```
interface IObservable<out T>
{
  //connect to underlying source (e.g. event source)
  IDisposable Attach(IObserver<T> o)
}
interface IObserver<out T>
{
  //enqueue/process next observable
  void OnNext(T)
  //error handling for improper stream termination
  void OnError(Exception e)
  //handle proper stream termination
  void OnCompleted( )
}
```

In a particular embodiment, each observer of a particular observable event is registered with a source of the particular observable event, and the source notifies (e.g., via push mechanism) registered observers each time the observable event occurs. In another particular embodiment, observable streams are used to transmit the events themselves (e.g., instantiations of event software classes) to registered observers instead of mere notifications or indications that events have occurred.

Generally, the processing of observable events using join patterns as disclosed herein employs asynchronous programming principles such as the “push” paradigm, as opposed to synchronous programming principles such as the “pull” paradigm. The difference between “push” and “pull” paradigms may be illustrated by considering an example related to a sushi restaurant. If the restaurant has an a la carte sushi menu, patrons that order off the menu effectively employ a “pull” paradigm, because the patrons decide when and what kind of sushi to order. In contrast, if the restaurant has a conveyer belt sushi bar, a “push” paradigm is employed. The chefs decide when and what kind of sushi is placed on the conveyer belt, and a patron consumes a particular piece of sushi off the conveyer belt if the ingredients of the sushi match the patron's taste preferences. The items on the conveyer belt may be considered observables, the people seated at the bar may be considered observers, and the individual taste preferences of the people may be considered join patterns.

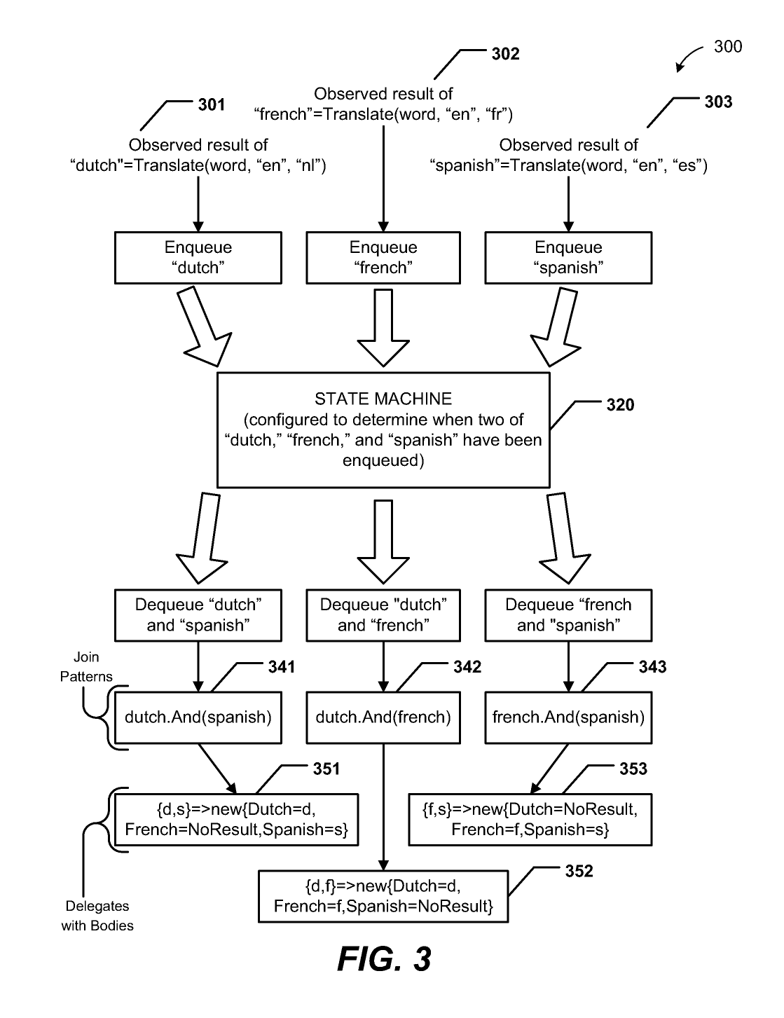

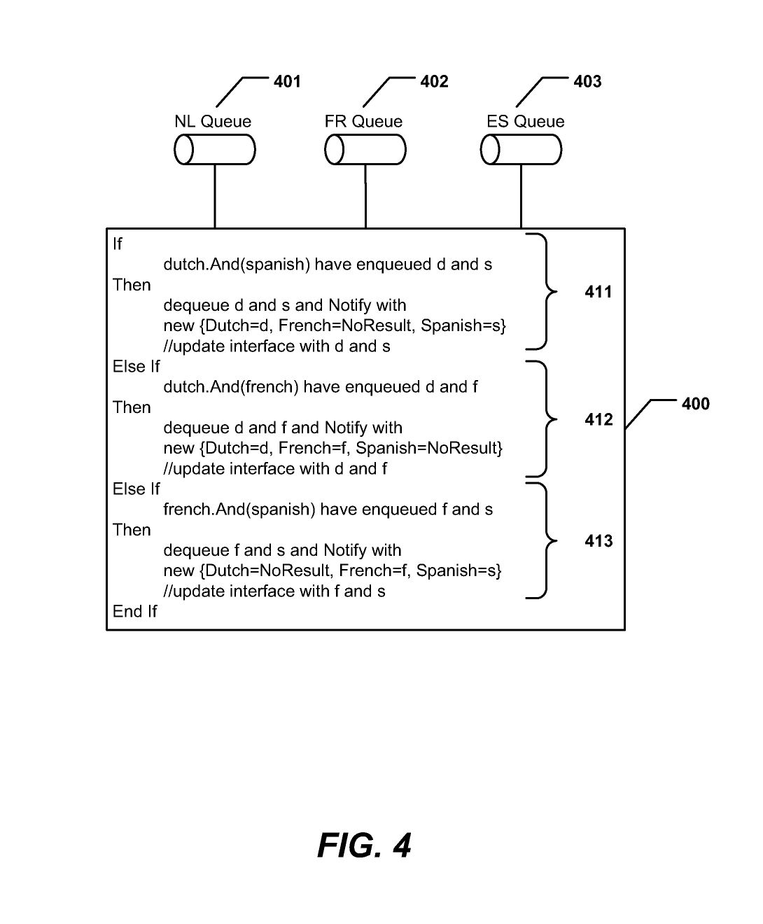

The state machine 120 includes one or more join patterns (e.g., an illustrative join pattern 122) and join pattern determination logic 124. Join patterns may include logical operations such as conjunctions (“and” operations) and disjunctions (“or” operations) with respect to observable events pushed via the observable streams 102 and 104. For example, the join pattern 122 “1st && 2nd” indicates that the join pattern 122 is satisfied when an observable event from each of the first observable stream 102 and the second observable stream 104 has been enqueued. The first observable stream 102 and the second observable stream 104 may be asynchronous channels. For example, the first observable stream 102 and the second observable stream 104 may be used for asynchronous pushing of observable events, or notifications thereof, from event sources to registered observers. In a particular embodiment, the determination that the join pattern 122 is satisfied triggers execution of a delegate function. For example, the delegate function may process the first observable event and the second observable event to produce a result. Delegate functions are further described with reference to FIGS. 3-4. In a particular embodiment, the result produced by the delegate function is also an observable event and is output via the target observable stream 130.

In operation, observable events from the first observable stream 102 and the second observable stream 104 may be enqueued as they are received. For example, a first execution thread at a computer system may observe and enqueue events pushed via the first observable stream 102 and a second execution thread at the computer system may observe enqueue events pushed via the second observable stream 104. The state machine 120 may respond to the enqueueing of observable events by determining whether the enqueued observable events satisfy the join pattern 122. If the join pattern 122 is satisfied, one or more actions (e.g., delegate function execution) may be performed. The one or more actions may result in a target observable event that is pushed to a target observer via the target observable stream 130. For example, in the keno example described above, the target observable of the CashWinningTicket( ) delegate function may be a “VerifiedWinningTicket” event that is pushed out to a “CasinoCashier” observer.

It will thus be appreciated that the system 100 of FIG. 1 may enable processing and synchronization of multiple observable events using join patterns. For example, multiple asynchronous events may be received concurrently and processed to produce results that are output sequentially. It will also be appreciated that join patterns may include any combination of logical operators, thereby enabling software developers to implement conditional asynchronous programming scenarios. It will further be appreciated that processing of observable events using join patterns as described herein may be used in many applications. By way of example, and not limitation, such applications may include event handling, user interfaces (UIs), stock market bid/offer applications, multiplayer games, pattern matching, multi-user systems, search engines, distributed (e.g., cloud-based) computing and any other software development scenario in which the frequency/number of events/data items to be processed is unpredictable or communication latency exists between threads.

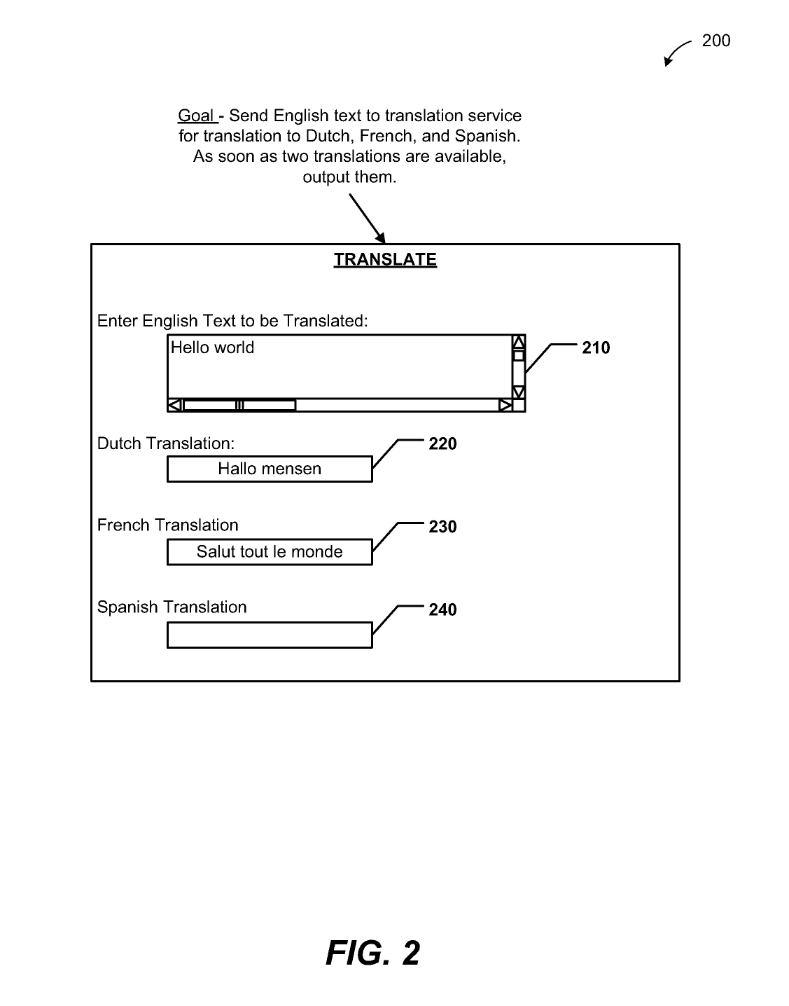

FIGS. 2-4 depict an exemplary software application that uses processing of observable events using join patterns as disclosed herein. For example, consider a user interface (UI) 200 for language translation. The UI 200 may include UI components such as an input text box 210 and output text fields 220, 230, and 240. In the particular embodiment illustrated in FIG. 2, the input text box 210 may accept English text to be translated, the first text field 220 may display English to Dutch translations, the second text field 230 may display English to French translations, and the third text field 240 may display English to Spanish translations. In a particular embodiment, the UI 200 may be developed as an input/output interface for a translation service.

Because each of the three translations may execute independently (e.g., on separate threads), the programmer may desire that the UI 200 be updated with translation results as soon as two of the three translations are available (as opposed to waiting until all three are available). Such a UI 200 may be implemented in accordance with the asynchronous programming principles described herein. For example, implementing such a UI 200 may include the following .NET code and Language Integrated Query (LINQ) expression, where join patterns are italicized and delegates are underlined for reference:

```
var translations = from word in words
  let dutch = Translate(word, “en”, “nl”)
  let french = Translate(word, “en”, “fr”)
  let spanish = Translate(word, “en”, “es”)
  from results in Observable.Join
    ( dutch.And(spanish).Then((d,s)=> new{Dutch=d,
      French=NoResult, Spanish=s}),
    dutch.And(french).Then((d,f)=> new{Dutch=d,
      French=f, Spanish=NoResult}),
    french.And (spanish).Then((f,s)=>
      new{Dutch=NoResult, French=f, Spanish=s})
    ) .Until(words)
  select results;
```

Updating the UI 200 may include subscribing to the translation results:

```
translations.Subscribe(result =>
{
  Dutch.InnerText=result.Dutch.GetTranslatedTerm( );
  French.InnerText=result.French.GetTranslatedTerm( );
  Spanish.InnerText=result.Spanish.GetTranslatedTerm( );
});
```

For example, the UI 200 depicted in FIG. 2 has been updated with a Dutch translation “Hallo mensen” and a French translation “Salut tout le monde” of the input text “Hello world.”

FIG. 3 depicts a particular embodiment of a system 300 of operation at the UI 200 depicted in FIG. 2. Once a user has filled the input text box 210 of FIG. 2, three calls to a translation function exposed by the translation service may be made. For example, the function calls may be Translate (word, “en”, “nl”), Translate (word, “en”, “fr”), and Translate (word, “en”, “es”). The results of each function call may be encapsulated in an observable event and received via an asynchronous channel, as illustrated by the observed results 301, 302, and 303. The results 301, 302, and 303 may be enqueued and processed by a state machine 320 that is configured to determine when two of the three results 301, 302, and 303 have been enqueued. In a particular embodiment, translation results may be encapsulated into an observable by specifying the return type of Translate( ) as an observable:

```
IObservable<TranslationResponse> Translate(
  this string text,
  string sourceLanguage,
  string destinationLanguage)
  {...}
```

When two results have been enqueued, the state machine 320 may trigger dequeueing of the two results upon determining that the two results match a join pattern. For example, if the two enqueued results are the results 301 and 303, the join pattern 341 “dutch.And(spanish)” may be matched. Similarly, if the two enqueued results are the results 301 and 302, the join pattern 342 “dutch.And(french)” may be matched, and if the two enqueued results are the results 302 and 303, the join pattern 343 “french.And(spanish)” may be matched. When a particular join pattern is matched, a delegate function associated with the join pattern may be executed. For example, the delegates 351, 352, and 353 may be associated with the join patterns 341, 342, and 343, respectively. An overall join pattern for the state machine may be represented by a logical disjunction of the three logical conjunctions: “dutch.And(spanish) OR dutch.And(french) OR french.And(spanish).”

FIG. 4 depicts a particular embodiment of a pseudocode representation of operation at the UI 200 of FIG. 2. As illustrated in FIG. 4, operation at the UI 200 of FIG. 2 includes access to three queues 401-403. The first queue 401 may store results of English to Dutch translation, the second queue 402 may store results of English to French translation, and the third queue 403 may store results of English to Spanish translation.

The pseudocode 400 may generally be divided into three sections 411, 412, and 413. In accordance with the first section 411, if the first queue 401 and the third queue 403 include a translation result “d” and “s” respectively, then “d” and “s” are dequeued and the interface is updated with “d” and “s.” Similarly, in accordance with the second section 412, if the first queue 401 and the second queue 403 include a translation result “d” and “f” respectively, then “d” and “f” are dequeued and the interface is updated with “d” and “f. In accordance with the third section 413, if the second queue 402 and the third queue 403 include a translation result “f” and “s” respectively, then “f” and “s” are dequeued and the interface is updated with “f” and “s.” For example, the UI 200 depicted in FIG. 2 has been updated with a Dutch translation “Hallo mensen” and a French translation “Salut tout le monde” of the input text “Hello world.”

It will be appreciated that processing observable events using join patterns, as illustrated by the example in FIGS. 2-4, may enable software developers to quickly develop and deploy programs that utilize asynchronous design patterns. For example, because delegates may be used to define what happens when a join pattern is satisfied, the framework disclosed herein may enable preconditions for asynchronous function execution, the asynchronous functions themselves, and other functionality (e.g., UI code) to be written and maintained independently. It should be noted that although the example of FIGS. 2-4 is described using C#, .NET, and LINQ principles, processing observable events using join patterns as described herein may be performed by other programming languages.

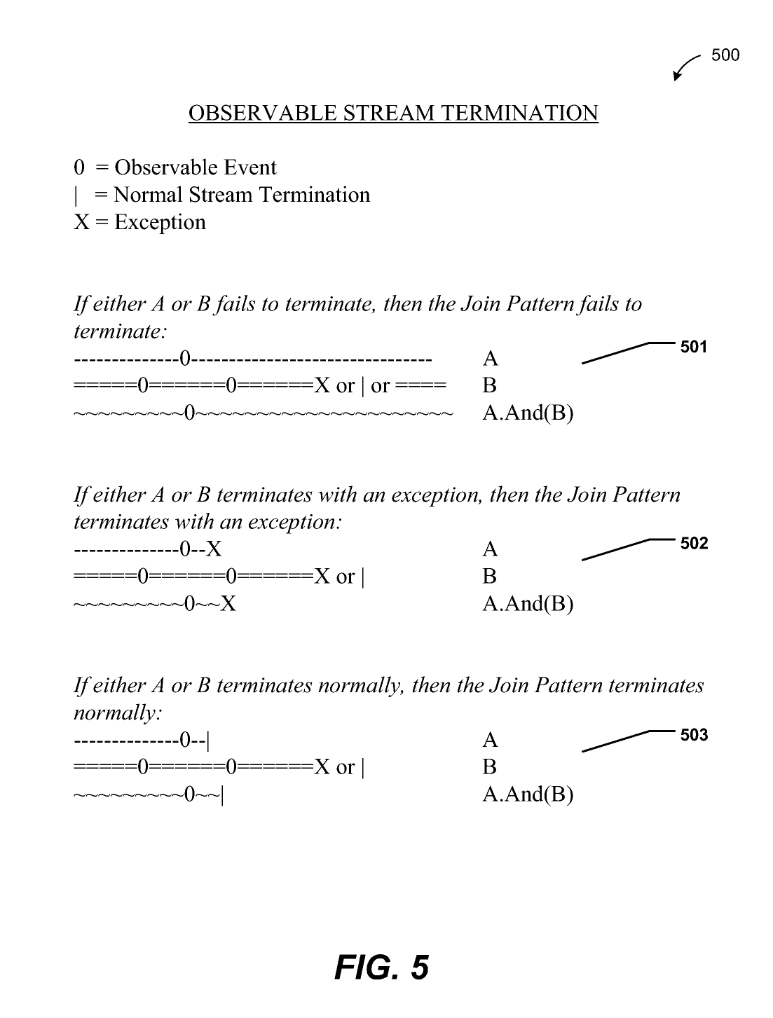

FIG. 5 is a diagram to illustrate observable stream termination examples in a two-stream system such as the system 100 of FIG. 1. For consistency, each of the examples 501, 502, and 503 are described with reference to two observable streams A and B and a logical conjunction join pattern A.And(B).

The first example 501 illustrates a situation in which one of the observable streams fails to terminate. When one of the streams (e.g., stream A) fails to terminate, the join pattern may also fail to terminate. It should be noted that the join pattern may fail to terminate regardless of whether the other stream (e.g., stream B) terminates normally or terminates with an exception.

The second example 502 illustrates a situation in which one of the observable streams terminates with an exception. When one of the streams (e.g., stream A) terminates with an exception, the join pattern may also terminate with an exception. It should be noted that the join pattern may terminate with an exception regardless of whether the other stream (e.g., stream B) terminates normally or also terminates with an exception.

The third example 503 illustrates a situation in which one of the observable streams terminates normally. When one of the streams (e.g., stream A) terminates normally, the join pattern may also terminate normally. It should be noted that the join pattern may terminate normally regardless of whether the other stream (e.g., stream B) also terminates normally or terminates with an exception.

Although the examples 501, 502, and 503 are illustrated with a conjunction join pattern, it should be noted that analogous stream termination scenarios exist for disjunction join patterns. For example, for a disjunction join pattern, the third example 503 may be modified to indicate that the join pattern will terminate normally when each part of the disjunction has terminated normally.

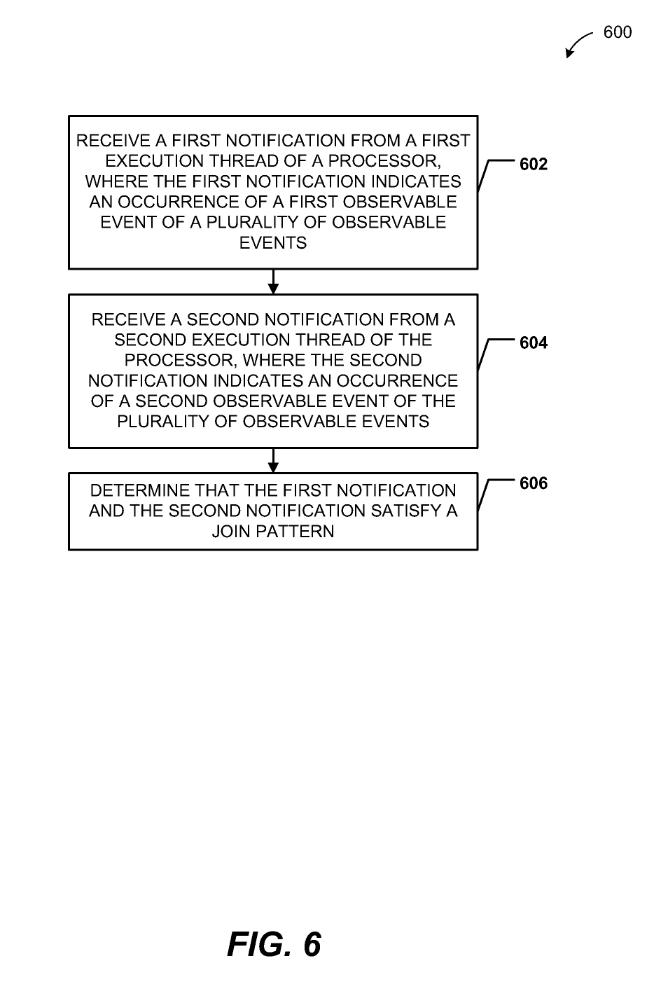

FIG. 6 is a flow diagram to illustrate a particular embodiment of a method 600 of processing observable events using join patterns. In an illustrative embodiment, the method 600 may be performed by the system 100 of FIG. 1 or the system 300 of FIG. 3.

The method 600 includes receiving a first notification from a first execution thread of a processor, where the first notification indicates an occurrence of a first observable event of a plurality of observable events, at 602. For example, in FIG. 1, a notification may be received via the first observable stream 102.

The method 600 also includes receiving a second notification from a second execution thread of a processor, where the second notification indicates an occurrence of a second observable event of the plurality of observable events, at 604. For example, in FIG. 1, a notification may be received via the second observable stream 104.

The method 600 further includes determining that the first notification and the second notification satisfy a join pattern. For example, in FIG. 1, the state machine 120 may determine that the notifications satisfy the join pattern 122.

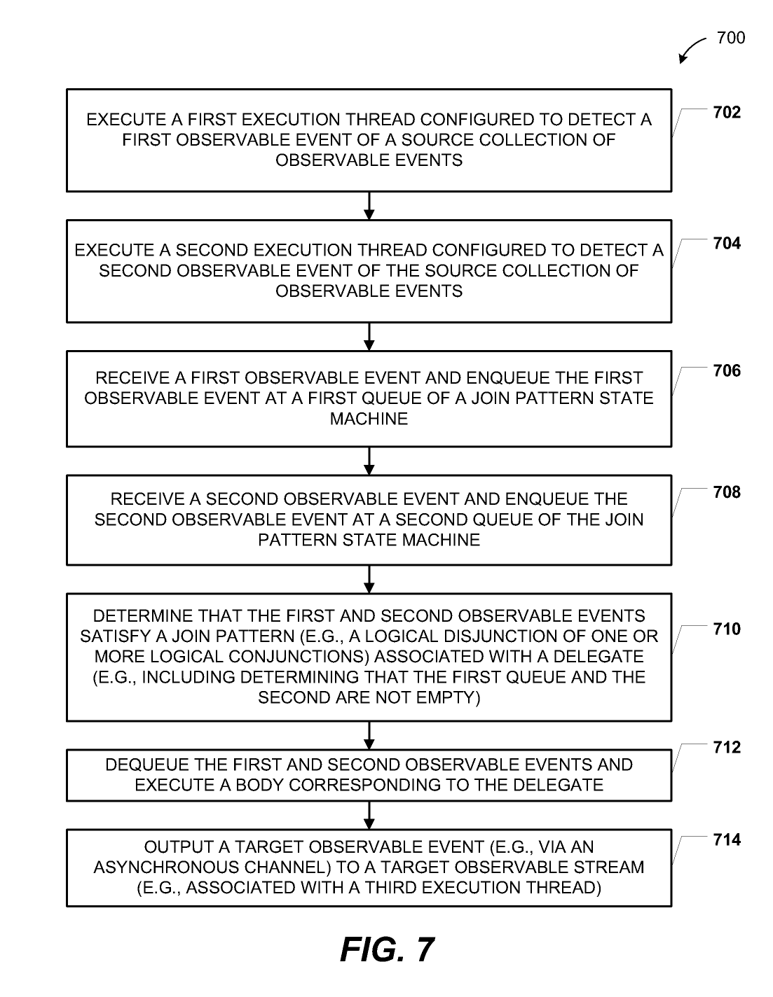

FIG. 7 is a flow diagram to illustrate another particular embodiment of a method 700 of processing observable events using join patterns. In an illustrative embodiment, the method 700 may be performed by the system 100 of FIG. 1 or the system 300 of FIG. 3.

The method 700 includes executing a first execution thread configured to detect a first observable event of a source collection of observable events, at 702, and executing a second execution thread configured to detect a second observable event of the source collection of observable events, at 704. For example, in FIG. 3, a first thread may execute English to Dutch translation to produce the first result 301 and a second thread may execute English to French translation to produce the second result 302.

The method 700 also includes receiving the first observable event and enqueueing the first observable event at a first queue of a join pattern state machine, at 706. For example, in FIG. 3, the first result 301 may be received and enqueued at the state machine 320. The method 700 further includes receiving the second observable event and enqueueing the second observable event at a second queue of the join pattern state machine, at 708. For example, in FIG. 3, the second result 302 may be received and enqueued at the state machine 320.

The method 700 includes determining that the first and second observable events satisfy a join pattern associated with a delegate, at 710. For example, the join pattern may be a logical disjunction of one or more logical conjunctions. In a particular embodiment, determining that the first and second observable events satisfy the join pattern includes determining that the first queue and the second queue are not empty. For example, in FIG. 3, the state machine 320 may determine that the first result 301 and the second result 302 satisfy the join pattern 342 “dutch.And(french).”

The method 700 also includes dequeueing the first and second observable events and executing a body corresponding to the delegate, at 712. For example, in FIG. 3, the first result 301 and the second result 302 may be dequeued and the delegate 352 “{d,f}=>new{Dutch=d, French=f, Spanish=NoResult}” may be executed. The method 700 further includes outputting a target observable event to a target observable stream. In a particular embodiment, the target observable event may by output via an asynchronous channel and the target observable stream may be associated with a third execution thread (e.g., the third execution thread may be used to asynchronously notify registered observers of the target observable stream). For example, the target observable stream may operate as described with reference to the target observable stream 130 of FIG. 1.

It will thus be appreciated that the method 700 of FIG. 7 may enable processing and synchronization of multiple observable events using join patterns. It will also be appreciated that join patterns may include any combination of logical operators, thereby enabling software developers to implement conditional asynchronous programming scenarios.

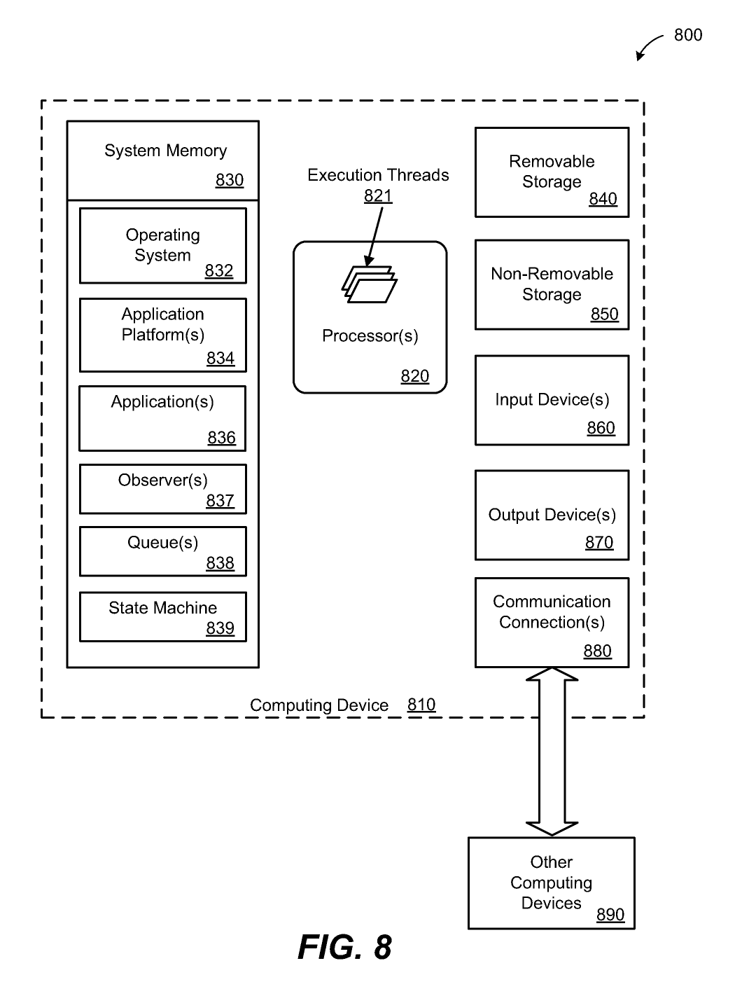

FIG. 8 depicts a block diagram of a computing environment 800 including a computing device 810 operable to support embodiments of computer-implemented methods, computer program products, and system components according to the present disclosure. In an illustrative embodiment, the computing device 810 may include one or more of the streams 102, 104, and 130 (e.g., represented by shared memory used for inter-thread communication) of FIG. 1, the state machine 120 of FIG. 1, and the state machine 320 of FIG. 3. Each of the streams 102, 104, and 130 of FIG. 1, the state machine 120 of FIG. 1, and the state machine 320 of FIG. 3 may include or be implemented using the computing device 810 or a portion thereof.

The computing device 810 includes at least one processor 820 and a system memory 830. The at least one processor 820 is configured to execute one or more execution threads 821. Depending on the configuration and type of computing device, the system memory 830 may be volatile (such as random access memory or “RAM”), non-volatile (such as read-only memory or “ROM,” flash memory, and similar memory devices that maintain stored data even when power is not provided), or some combination of the two. The system memory 830 typically includes an operating system 832, one or more application platforms 834, one or more applications 836, and program data (e.g., one or more observers 837, one or more queues 838, and a state machine 839) associated with the one or more applications. In an illustrative embodiment, the one or more queues 838 include the queues 401-403 of FIG. 4. In another illustrative embodiment, the state machine 839 includes the state machine 120 of FIG. 1 or the state machine 320 of FIG. 3.

The computing device 810 may also have additional features or functionality. For example, the computing device 810 may also include removable and/or non-removable additional data storage devices such as magnetic disks, optical disks, tape, and standard-sized or flash memory cards. Such additional storage is illustrated in FIG. 8 by removable storage 840 and non-removable storage 850. Computer storage media may include volatile and/or non-volatile storage and removable and/or non-removable media implemented in any technology for storage of information such as computer-readable instructions, data structures, program components or other data. The system memory 830, the removable storage 840 and the non-removable storage 850 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 810. Any such computer storage media may be part of the computing device 810.

The computing device 810 may also have input device(s) 860, such as a keyboard, mouse, pen, voice input device, touch input device, etc. Output device(s) 870, such as a display, speakers, printer, etc. may also be included. The computing device 810 also contains one or more communication connections 880 that allow the computing device 810 to communicate with other computing devices 890 over a wired or a wireless network.

It will be appreciated that not all of the components or devices illustrated in FIG. 8 or otherwise described in the previous paragraphs are necessary to support embodiments as herein described. For example, the removable storage 840 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer system, comprising:
a processor configured to:
execute a plurality of observers at a plurality of execution threads, wherein each particular observer of the plurality of observers is configured to detect one or more occurrences of a particular observable event of a plurality of observable events; and
a memory storing instructions, that when executed by the processor, cause execution of a state machine configured to:
receive notifications associated with occurrences of the plurality of observable events from the plurality of observers; and
determine that a particular set of received notifications satisfies a join pattern.

2. The system of claim 1, wherein each of the plurality of observers comprises an instantiation of an observer software class.

3. The system of claim 1, wherein the particular observer is registered with a source of the particular observable event, wherein the source is configured to notify the particular observer of occurrences of the particular observable event.

4. The system of claim 1, wherein the join pattern includes at least one logical conjunction.

5. The system of claim 1, wherein the join pattern includes at least one logical disjunction.

6. The system of claim 5, wherein the at least one logical disjunction is a logical disjunction of two or more logical conjunctions.

7. The system of claim 1, wherein the particular observer is configured to receive an indication of a particular occurrence of the particular observable event via a push mechanism.

8. The system of claim 1, wherein at least one observer of the plurality of observers communicates with the state machine via an asynchronous channel.

9. The system of claim 1, wherein the join pattern is associated with a delegate.

10. The system of claim 9, wherein the state machine is further configured to execute a body of the delegate in response to determining that the particular set of received notifications satisfies the join pattern.

11. The system of claim 10, wherein executing the body comprises outputting a result.

12. The system of claim 11, wherein the result is an observable event and wherein the result is output via an asynchronous channel to an observer.

13. A computer-implemented method, comprising:
receiving a first notification from a first execution thread of a processor, wherein the first notification indicates an occurrence of a first observable event of a plurality of observable events;
receiving a second notification from a second execution thread of the processor, wherein the second notification indicates an occurrence of a second observable event of the plurality of observable events; and
determining the first notification and the second notification satisfy a join pattern that comprises a logical disjunction of one or more logical conjunctions.

14. The computer-implemented method of claim 13, wherein the first execution thread is associated with a first observable stream and the second execution thread is associated with a second observable stream.

15. The computer-implemented method of claim 14, wherein:
the join pattern terminates with an exception when one of the first observable stream and the second observable stream terminates with an exception;
the join pattern terminates normally when one of the first observable stream and the second observable stream terminates normally; and
the join pattern fails to terminate when one of the first observable stream and the second observable stream fails to terminate.

16. A computer-readable medium comprising instructions, that when executed by a computer, cause the computer to:
execute a first execution thread configured to detect a first observable event of a source collection of observable events;
execute a second execution thread configured to detect a second observable event of the source collection of observable events;
receive a first observable event;
receive a second observable event;
determine that the first observable event and the second observable satisfy a join pattern associated with a delegate, wherein the join pattern comprises a logical disjunction of one or more logical conjunctions; and
output a target observable event to a target observable stream.

17. The computer-readable medium of claim 16, further comprising enqueueing the first observable event at a first queue of a join pattern state machine and enqueueing the second observable event at a second queue of the join pattern state machine.

18. The computer-readable medium of claim 17, wherein determining that the first observable event and the second observable event satisfy the join pattern comprises determining that each of the first queue and the second queue are not empty.

19. The computer-readable medium of claim 17, further comprising instructions, that when executed by the computer, cause the computer to:
dequeue the first observable event from the first queue;
dequeue the second observable event from the second queue; and
execute a body corresponding to the delegate.

20. The computer-readable medium of claim 16, wherein the target observable stream is associated with a third execution thread.
